(19) United States
(12) Patent Application Publication
(10) Pub. No.: US 2005/0114722 A1
(43) Pub. Date: May 26, 2005

(54) Semiconductor integrated circuit and microprocessor unit switching method

(75) Inventors: Isao Tanaka, Osaka (JP); Yuji Takai, Osaka (JP); Hiroshi Mizuno, Osaka (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 10/995,416

(22) Filed: Nov. 24, 2004

(30) Foreign Application Priority Data
Nov. 25, 2003 (JP) 2003-393624

(51) Int. Cl. G06F 1/26

(52) U.S. Cl. 713/320

(57) ABSTRACT

Processing is executed by using transistors having a low threshold voltage in a general operation and by using transistors having a high threshold voltage in a standby operation or the like, so as to attain both a high speed operation and a low leakage current. An MPU includes a first MPU constructed from transistors having a high threshold voltage and a second MPU constructed from transistors having a low threshold voltage. When an MPU switching instruction appears on a given instruction stream, data of the first MPU is saved in an external memory section, this data is transferred to the second MPU after switching the control to the second MPU, and the first MPU is disconnected from power by a power control section. Also, when the general operation is switched to the standby operation, the second MPU is switched to the first MPU in the reverse sequence.

### CROSS-REFERENCE TO RELATED APLICATIONS

This application claims priority under 35 U.S.C. §119 on Patent Application No. 2003-393624 filed in Japan on Nov. 25, 2003, the entire contents of which are hereby incorporated by reference.

### BACKGROUND OF THE INVENTION

The present invention relates to a semiconductor integrated circuit mounting a built-in microprocessor, and more particularly, it relates to a semiconductor integrated circuit and a microprocessor unit switching method for attaining both high speed processing and a low leakage current, to be employed when a power supply voltage and a threshold voltage of transistors are lowered through scaling as a result of refinement in semiconductor integrated circuit processing technology.

In order to cope with lowering of an element breakdown voltage derived from refinement of MOS transistors, it is now necessary to lower a power supply voltage. When a power supply voltage is so high that the amplitude of a threshold voltage can be ignored, a delay time is in inverse proportion to the power supply voltage, but when the power supply voltage is lowered, the delay time is abruptly increased in accordance with the lowering of the power supply voltage. Therefore, in order to keep high speed processing of an integrated circuit, it is necessary to lower the threshold voltage of MOS transistors in accordance with the lowering rate of the power supply voltage. However, when the threshold voltage of MOS transistors is lowered, there arises a problem that a leakage current derived from a subthreshold current of the MOS transistors is increased. In order to solve this problem, for example, Japanese-Laid Open Patent Publication No. 10-189884 proposes a method for changing the threshold voltage of MOS transistors by controlling a substrate bias in accordance with an operation mode.

In this conventional technique, the threshold voltage of the MOS transistors themselves are set to be low, so that a high speed operation can be performed under application of a low power supply voltage in a general operation mode. In a standby mode, such as waiting processing, in which high speed processing is not necessary, the threshold voltage of the MOS transistors is increased by applying a substrate bias, so that a leakage current can be reduced.

In order to perform substrate bias control in the aforementioned manner, however, it is necessary to separate a substrate node of each MOS transistor from a power supply line, and hence, it is disadvantageously necessary to employ a special cell structure. Also, in order to achieve a substrate bias effect sufficiently high for largely changing the threshold voltage for reducing a leakage current, it is necessary to generate a large reverse bias between the substrate and the source, which increases design complexity because it is necessary to consider device reliability such as a breakdown voltage of the transistors. In particular, when the device is further refined, the effect to reduce the leakage current by the substrate bias effect is reduced as the range of changing the threshold voltage against the applied reverse bias is smaller, and furthermore, the contribution of a component of a gate leakage current, which cannot be reduced through the substrate bias control, becomes large. Accordingly, there is a demand for a method for reducing a leakage current alternative to the substrate bias control.

### SUMMARY OF THE INVENTION

In consideration of the aforementioned conventional disadvantages, an object of the invention is properly using MOS transistors having different threshold voltages so that MOS transistors having a low threshold voltage and capable of a high speed operation are used in a general operation mode necessary to be rapidly processed and MOS transistors having a high threshold voltage and a small leakage current are used in an operation mode not necessary to be rapidly performed, without employing a special cell structure for separating a power supply line and complicated design in consideration of a breakdown voltage of transistors.

In order to achieve the object, a semiconductor integrated circuit of the present invention includes two microprocessor units that respectively include transistors having different threshold voltages from each other and between which a basic instruction set is equivalent or upward compatible. In a general operation mode in which the semiconductor integrated circuit is operated at a given operating ratio and requires a high speed operation, the microprocessor unit constructed from the transistors having a low threshold voltage is used, and in an operation mode in which it is operated at an operating ratio lower than the given operating ratio and does not require a high speed operation, the microprocessor unit constructed from the transistors having a high threshold voltage is used, and in this case, the other microprocessor unit not used is disconnected from power. Thus, both high speed processing and low-leakage current processing can be attained.

Specifically, the semiconductor integrated circuit of this invention includes a microprocessor unit for processing a given instruction stream; and a power control section for controlling power supply to the microprocessor unit, and the microprocessor unit includes a first microprocessor unit that is constructed from transistors having a first threshold voltage and a second microprocessor unit that is constructed from transistors having a second threshold voltage lower than the first threshold voltage and is instruction set compatible with the first microprocessor unit, in processing that is executed by the microprocessor unit including the first and second microprocessor units and is composed of a first operation mode for performing a general operation with a given operating ratio and a second operation mode for performing an operation with a lower operating ratio than the first operation mode, the given instruction stream includes a first MPU switching instruction received by the first microprocessor unit for switching the first microprocessor unit to the second microprocessor unit when the second operation mode with the lower operating ratio is changed to the first operation mode with the given operating ratio, and a second MPU switching instruction received by the second microprocessor unit for switching the second microprocessor unit to the first microprocessor unit when the first operation mode with the given operating ratio is changed to the second operation mode with the lower operating ratio, and when the first operation mode is changed to the second operation mode, the microprocessor unit including the first and second microprocessor units performs, by using the power control section, power control for making the second microprocessor unit having received the second MPU switching instruction supply power to the first microprocessor unit and disconnecting the second microprocessor unit from power, and when the second operation mode is changed to the first operation mode, the microprocessor unit including the first and second microprocessor units performs, by using the power control section, power control for making the first microprocessor unit having received the first MPU switching instruction supply power to the second microprocessor unit and disconnecting the first microprocessor unit from power.

In one aspect of the invention, the semiconductor integrated circuit further includes a first memory section and a first control section in the first microprocessor unit; a second memory section and a second control section in the second microprocessor unit; and an external memory section for storing data of the first or second memory section, and in switching the first and second microprocessor units on the basis of the first and second MPU switching instructions, the first and second control sections control, by using the external memory section, data transfer from the first or second memory section of the first or second microprocessor unit to be disconnected from power to the second or first memory section of the second or first microprocessor unit to be supplied with power.

The first microprocessor unit switching method of this invention for switching the first and second microprocessor units of the semiconductor integrated circuit, includes an MPU1 data transferring step of transferring data stored in the first memory section of the first microprocessor unit to the external memory section in accordance with the given instruction stream to be processed by the first microprocessor unit; an MPU2 power supplying step of making the power control section supply power to a power supply system of the second microprocessor unit in accordance with the given instruction stream to be processed by the first microprocessor unit; an MPU1 power disconnecting step of making the power control section disconnect a power supply system of the first microprocessor unit from power in accordance with the given instruction stream to be processed by the first microprocessor unit; an MPU2 data storing step of storing the data having been stored in the external memory section in the second memory section of the second microprocessor unit in accordance with the given instruction stream to be processed by the second microprocessor unit; an MPU2 data transferring step of transferring data stored in the second memory section of the second microprocessor unit to the external memory section in accordance with the given instruction stream to be processed by the second microprocessor unit; an MPU1 power supplying step of making the power control section supply power to the power supply system of the first microprocessor unit in accordance with the given instruction stream to be processed by the second microprocessor unit; an MPU2 power disconnecting step of making the power control section disconnect the power supply system of the second microprocessor unit from power in accordance with the given instruction stream to be processed by the second microprocessor unit; and an MPU1 data storing step of storing the data having been stored in the external memory section in the first memory section of the first microprocessor unit in accordance with the given instruction stream to be processed by the first microprocessor unit.

In another aspect of the semiconductor integrated circuit, the first microprocessor unit includes a first memory section and a first control section, the second microprocessor unit includes a second memory section and a second control section, the microprocessor unit including the first and second microprocessor units further includes a data transfer section for performing data transfer between the first memory section and the second memory section; and an MPU control section for controlling the data transfer performed by the data transfer section on the basis of signals received from the first and second control sections, and in switching the first and second microprocessor units on the basis of the first and second MPU switching instructions, the first and second control sections controls, by using the MPU control section, the data transfer section in such a manner that data of the first or second memory section of the first or second microprocessor unit to be disconnected from power is transferred to the second or first memory section of the second or first microprocessor unit to be supplied with power.

The second microprocessor unit switching method of this invention for switching the first and second microprocessor units of the semiconductor integrated circuit, includes an MPU2 power supplying step of making the power control section supply power to a power supply system of the second microprocessor unit in accordance with the given instruction stream to be processed by the first microprocessor unit; an MPU1 data transferring step of transferring data stored in the first memory section of the first microprocessor unit to the second memory section of the second microprocessor unit in accordance with the given instruction stream to be processed by the first microprocessor unit; an MPU1 power disconnecting step of making the power control section disconnect a power supply system of the first microprocessor unit from power in accordance with the given instruction stream to be processed by the first microprocessor unit; an MPU1 power supplying step of making the power control section supply power to the power supply system of the first microprocessor unit in accordance with the given instruction stream to be processed by the second microprocessor unit; an MPU2 data transferring step of transferring data stored in the second memory section of the second microprocessor unit to the first memory section of the first microprocessor unit in accordance with the given instruction stream to be processed by the second microprocessor unit; and an MPU2 power disconnecting step of making the power control section disconnect the power supply system of the second microprocessor unit from power in accordance with the given instruction stream to be processed by the second microprocessor unit.

In still another aspect of the semiconductor integrated circuit, the first microprocessor unit includes a first memory section and a first control section, the second microprocessor unit includes a second memory section and a second control section, the microprocessor unit including the first and second microprocessor units further includes a data write through section for performing data pass between the first memory section and the second memory section; and an MPU control section for controlling the data pass performed by the data write through section on the basis of signals received from the first and second control sections, and in switching the first and second microprocessor units on the basis of the first and second MPU switching instructions, the first and second control sections control, by using the MPU control section, the data write through section in such a manner that data of the first or second memory section of the first or second microprocessor unit to be disconnected from power is passed to the second or first memory section of the second or first microprocessor unit to be supplied with power.

In still another aspect of the semiconductor integrated circuit, the first microprocessor unit includes a first control section, the second microprocessor unit includes a second control section, and the microprocessor unit further includes a memory section shared by the first and second microprocessor units; and an MPU control section for controlling data store in the memory section on the basis of signals received from the first and second control sections.

In still another aspect of the semiconductor integrated circuit, the memory section is constructed from transistors having a threshold voltage equal to the first threshold voltage or the second threshold voltage.

In still another aspect of the semiconductor integrated circuit, the first microprocessor unit includes a first memory section and a first control section, the second microprocessor unit includes a second memory section and a second control section, and each of the first and second microprocessor units has both a master function and a slave function for performing data transfer between the first and second memory sections through master/slave operations of the first and second control sections.

The third microprocessor unit switching method of this invention for switching the first and second microprocessor units of the semiconductor integrated circuit, includes an MPU2 power supplying step of making the power control section supply power to a power supply system of the second microprocessor unit in accordance with the given instruction stream to be processed by the first microprocessor unit; an MPU1 data transferring step of transferring data stored in the first memory section of the first microprocessor unit to the second memory section of the second microprocessor unit in accordance with the given instruction stream to be processed by the first microprocessor unit; an MPU1 power disconnecting step of making the power control section disconnect a power supply system of the first microprocessor unit from power in accordance with the given instruction stream to be processed by the first microprocessor unit; an MPU1 power supplying step of making the power control section supply power to the power supply system of the first microprocessor unit in accordance with the given instruction stream to be processed by the second microprocessor unit; an MPU2 data transferring step of transferring data stored in the second memory section of the second microprocessor unit to the first memory section of the first microprocessor unit in accordance with the given instruction stream to be processed by the second microprocessor unit; and an MPU2 power disconnecting step of making the power control section disconnect the power supply system of the second microprocessor unit from power in accordance with the given instruction stream to be processed by the second microprocessor unit.

In another aspect, the semiconductor integrated circuit further includes, outside the microprocessor unit including the first and second microprocessor units, an external data transfer section for performing the data transfer between the first and second memory sections through independent processing controlled by the first and second control sections.

The fourth microprocessor unit switching method of this invention for switching the first and second microprocessor units of the semiconductor integrated circuit, includes an MPU2 power supplying step of making the power control section supply power to a power supply system of the second microprocessor unit in accordance with the given instruction stream to be processed by the first microprocessor unit; an MPU1 data transferring step of transferring data stored in the first memory section of the first microprocessor unit to the second memory section of the second microprocessor unit in accordance with the given instruction stream to be processed by the first microprocessor unit; an MPU1 power disconnecting step of making the power control section disconnect a power supply system of the first microprocessor unit from power in accordance with the given instruction stream to be processed by the first microprocessor unit; an MPU1 power supplying step of making the power control section supply power to the power supply system of the first microprocessor unit in accordance with the given instruction stream to be processed by the second microprocessor unit; an MPU2 data transferring step of transferring data stored in the second memory section of the second microprocessor unit to the first memory section of the first microprocessor unit in accordance with the given instruction stream to be processed by the second microprocessor unit; and an MPU2 power disconnecting step of making the power control section disconnect the power supply system of the second microprocessor unit from power in accordance with the given instruction stream to be processed by the second microprocessor unit.

In still another aspect, the semiconductor integrated circuit further includes at least one third microprocessor unit that is constructed from transistors having a third threshold voltage different from the first and second threshold voltages and is instruction set compatible with the first and second microprocessor units, and the given instruction stream includes an MPU switching instruction for allocating a given microprocessor unit out of the first, second and third microprocessor units constructed from the transistors respectively having the first, second and third threshold voltages to a load of processing to be performed in such a manner that a low threshold voltage is selected when the load is large and a high threshold voltage is selected when the load is small, and for switching a currently operated microprocessor unit to the given microprocessor unit when the load of processing is changed, and when the MPU switching instruction appears in executing the given instruction stream, the currently operated microprocessor unit executes the given instruction stream by performing, by using the power control section, power control for supplying power to the given microprocessor unit to be switched and disconnecting the currently operated microprocessor unit from power.

In this manner, according to the present invention, the first and second microprocessors are selectively switched in accordance with the characteristic of an instruction to be processed, so that the first microprocessor unit constructed from the transistors having the high threshold voltage can be used in an operation not requiring high speed processing and that the second microprocessor unit constructed from the transistors having the low threshold voltage can be used in a general operation requiring high speed processing. Furthermore, one of the first and second microprocessor units not used is disconnected from power by the external power control section. Thus, both high speed processing and low power consumption can be attained in the whole microprocessor unit including the first and second microprocessor units.

In particular, in the aspect using the data transfer section and the MPU control section, data stored in the first and second memory sections of the first and second microprocessor units are transferred through the data transfer section provided in the microprocessor unit including the first and second microprocessor units. Therefore, there is no need to consider an occupation period of buses.

Also, in the aspect using the data write through section in the microprocessor unit including the first and second microprocessor units, data is transferred every time the first and second memory sections are updated. Therefore, data identity can be kept between the first and second memory sections.

Furthermore, in the aspect using the memory section shared by the first and second microprocessor units, there is no need to transfer data in switching the first and second microprocessor units, and hence, a period for resetting or saving the data is not necessary.

Moreover, in the aspect where the first and second microprocessor units have the master/slave functions, one of the first and second microprocessor units can transfer data to the other through its master/slave operation. Therefore, there is no need to provide a memory section for data transfer outside the first and second microprocessor units.

In addition, in the aspect using the external data transfer section, provided outside the microprocessor unit including the first and second microprocessor units, for transferring the data of the first and second memory sections, the data can be transferred through independent processing of the external data transfer section, and thus, the processing to be executed by the microprocessor unit can be reduced.

### BRIEF DESCRIPTION OF THE DRAWINGS

FIG. 1 is a diagram for showing an example of the architecture of a semiconductor integrated circuit device according to Embodiment 1 of the invention;

FIG. 2 is a flowchart of a power control method employed when a unit used for operation control is switched from a first microprocessor unit to a second microprocessor unit in Embodiment 1;

FIG. 3 is a flowchart of a power control method employed when the unit used for the operation control is switched from the second microprocessor unit to the first microprocessor unit in Embodiment 1;

FIG. 4 is a diagram for showing an example of the architecture of a semiconductor integrated circuit device according to Embodiment 2 of the invention;

FIG. 5 is a flowchart of a power control method employed when a unit used for the operation control is switched from a first microprocessor unit to a second microprocessor unit in Embodiment 2;

FIG. 6 is a flowchart of a power control method employed when the unit used for the operation control is switched from the second microprocessor unit to the first microprocessor unit in Embodiment 2;

FIG. 7 is a diagram for showing an example of the architecture of a semiconductor integrated circuit device according to Embodiment 3 of the invention;

FIG. 8 is a flowchart of a power control method employed when a unit used for the operation control is switched from a first microprocessor unit to a second microprocessor unit in Embodiment 3;

FIG. 9 is a flowchart of a power control method employed when the unit used for the operation control is switched from the second microprocessor unit to the first microprocessor unit in Embodiment 3;

FIG. 10 is a diagram for showing an example of the architecture of a semiconductor integrated circuit device according to Embodiment 4 of the invention;

FIG. 11 is a flowchart of a power control method employed when a unit used for the operation control is switched from a first microprocessor unit to a second microprocessor unit in Embodiment 4;

FIG. 12 is a flowchart of a power control method employed when the unit used for the operation control is switched from the second microprocessor unit to the first microprocessor unit in Embodiment 4;

FIG. 13 is a diagram for showing an example of the architecture of a semiconductor integrated circuit device according to Embodiment 5 of the invention;

FIG. 14 is a flowchart of a power control method employed when a unit used for the operation control is switched from a first microprocessor unit to a second microprocessor unit in Embodiment 5;

FIG. 15 is a flowchart of a power control method employed when the unit used for the operation control is switched from the second microprocessor unit to the first microprocessor unit in Embodiment 5;

FIG. 16 is a diagram for showing an example of the architecture of a semiconductor integrated circuit device according to Embodiment 6 of the invention;

FIG. 17 is a flowchart of a power control method employed when a unit used for the operation control is switched from a first microprocessor unit to a second microprocessor unit in Embodiment 6;

FIG. 18 is a flowchart of a power control method employed when the unit used for the operation control is switched from the second microprocessor unit to the first microprocessor unit in Embodiment 6;

FIG. 19 is a diagram for showing an example of the relationship of the threshold voltage of a transistor with a delay time and a leakage current; and

FIG. 20 is a diagram of switching instructions for first and second microprocessor units appearing on an instruction stream to be processed by a microprocessor unit of the invention.

### DETAILED DESCRIPTION OF THE INVENTION

Now, preferred embodiments of a semiconductor integrated circuit and a microprocessor unit switching method according to the present invention will be described with reference to the accompanying drawings.

Embodiment 1

Embodiment 1 of the invention will now be described with reference to the drawings.

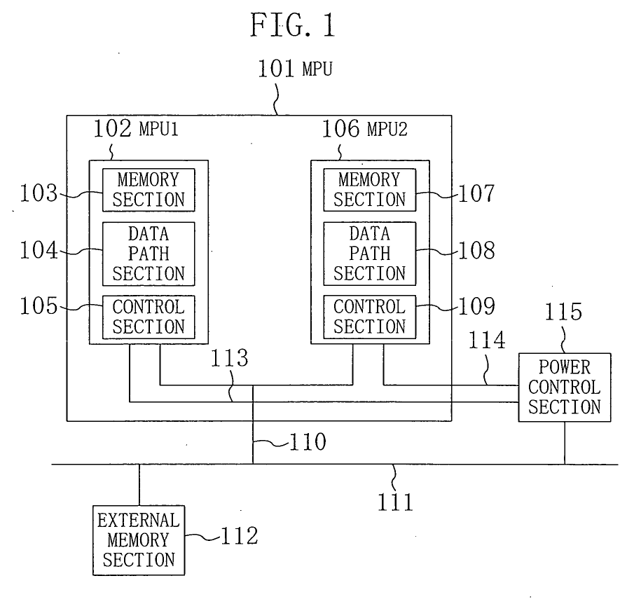

FIG. 1 shows a semiconductor integrated circuit device. A reference numeral 101 denotes a microprocessor unit (hereinafter sometimes referred to as the MPU), which includes two microprocessor units, that is, a first microprocessor unit 102 and a second microprocessor unit 106. The first microprocessor unit 102 is constructed from transistors having a first threshold voltage, the second microprocessor unit 106 is constructed from transistors having a second threshold voltage, and the first microprocessor unit 102 and the second microprocessor unit 106 are instruction set compatible with each other.

The first microprocessor unit 102 includes a memory section 103, a data path section 104 and a control section 105. The memory section 103 is constructed from registers and memories for storing data resulting from control and operation of the first microprocessor unit 102. The data path section 104 executes operation processing within the first microprocessor unit 102. The control section 105 controls the operation of the first microprocessor unit 102 in accordance with an instruction to be processed. The second microprocessor unit 106 includes a memory section 107, a data path section 108 and a control section 109. The memory section 107 is constructed from registers and memories for storing data resulting from control and operation of the second microprocessor unit 106. The data path section 108 executes operation processing within the second microprocessor unit 106. The control section 109 controls the operation of the second microprocessor unit 106 in accordance with an instruction to be processed.

Reference numerals 110 and 111 denote buses for transferring data and instructions, which connect the microprocessor unit 101 to an external memory section 112 and a power control section 115. In addition, a variety of other circuits are connected to the bus 111.

The external memory section 112 is externally provided to the microprocessor unit 101 for storing data sent from the first and second microprocessor units.

The power control section 115 controls power supply to be supplied to the first microprocessor unit 102 and the second microprocessor unit 106 in accordance with instructions supplied from the first microprocessor unit 102 and the second microprocessor unit 106, which are included in the microprocessor unit 101, respectively.

A first power supply system 113 and a second power supply system 114 respectively connect the first microprocessor unit 102 and the second microprocessor unit 106 to the power control section 115, and the power supplied to the first microprocessor unit 102 and the second microprocessor unit 106 is turned on/off by the power control section 115 respectively through the first power supply system 113 and the second power supply system 114.

Now, the first threshold voltage and the second threshold voltage will be described below. FIG. 19 is a diagram for showing an example of the relationship of the threshold voltage of a transistor with a delay time and a leakage current. In FIG. 19, the abscissa indicates the threshold voltage of a transistor. A line extending along black circles corresponds to a leakage current indicated by the left ordinate and is obtained by plotting leakage current values per unit gate width obtained when the transistor is in an off state. Such an off-leakage current is varied logarithmically against change of the threshold voltage. A line extending along white circles corresponds to a delay time indicated by the right ordinate and is obtained by plotting delay times of a standard logic gate with a standard line load. As shown in FIG. 19, when the threshold voltage is set, for example, to be as high as 0.5 V, the off-leakage current value is as small as 0.01 nA/um but the delay time is as large as 90 ps. On the other hand, when the threshold voltage is set to be as low as 0.2 V, the delay time is as small as 60 ps, namely, the circuit operation speed is high, but the off-leakage current value is as large as 10 nA/um. In this embodiment, the first threshold voltage is set to be as high as 0.5 V and the second threshold voltage is set to 0.2 V that is lower than the first threshold voltage. It is noted that the threshold voltage of a transistor is determined depending upon profile attained in semiconductor fabrication processing.

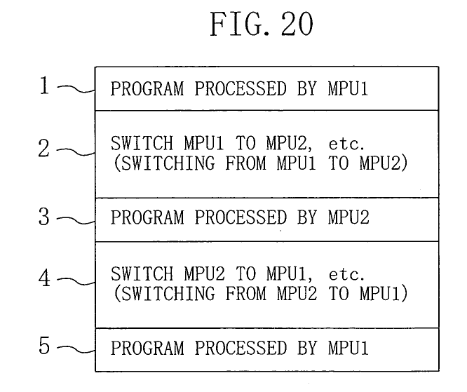

Furthermore, an instruction for switching the first and second microprocessor units 102 and 106 will be described with reference to FIG. 20 showing the outline of an instruction sequence to be processed by the microprocessor unit 101 of this embodiment. Instructions 1 and 5 of FIG. 20 are used for, for example, processing with a low operating ratio, such as waiting processing of equipment that is so-called the standby mode, or simple processing. Such processing in which the operation speed is negligible is executed by the first microprocessor unit 102 having a low-leakage current characteristic constructed from the transistors having the high threshold voltage. Also, an instruction 3 is used for processing with a high operating ratio such as a general operation that needs a high operation speed. Such processing is executed by the second microprocessor unit 106 capable of a high speed operation constructed from the transistors having the low threshold voltage.

In this case, for switching the first microprocessor unit 102 to the second microprocessor unit 106, an instruction 2 of FIG. 20, namely, a switching instruction such as “Switch MPU1 to MPU2 (a first MPU switching instruction)” is used. On the other hand, for switching the second microprocessor unit 106 to the first microprocessor unit 102, an instruction 4, namely, a switching instruction such as “Switch MPU2 to MPU1 (a second MPU switching instruction)” is used.

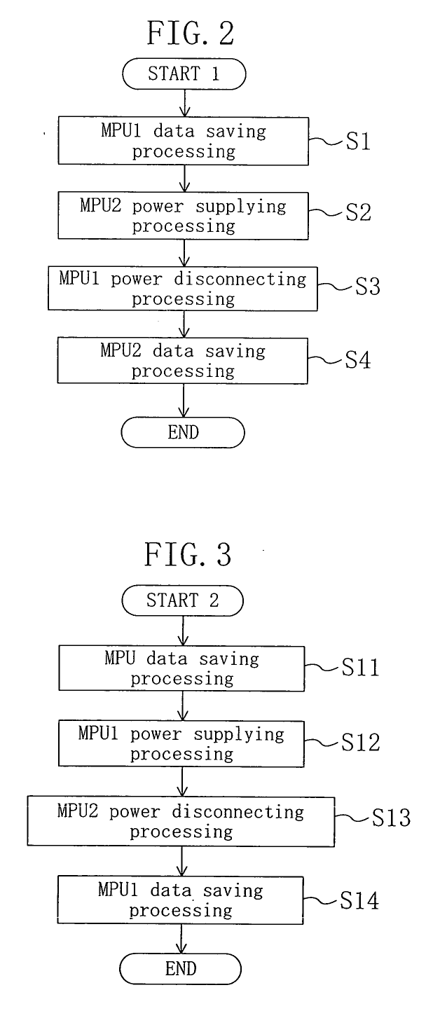

Next, a method for power control performed by the microprocessor unit 101 will be described with reference to flowcharts of FIGS. 2 and 3. In flowcharts mentioned in this and following embodiments, a start of an operation with a low operating ratio not requiring a high operation speed is designated as “START 1” and a start of a general operation requiring a high operation speed is designated as “START 2” for distinguishing these starts.

FIG. 2 is a flowchart for explaining a power control method employed when a unit used for operation control is switched from the first microprocessor unit 102 to the second microprocessor unit 106.

It is first assumed that power is supplied to the first microprocessor unit 102 from the first power supply system 113 and that the second microprocessor unit 106 is disconnected from power. When this state not requiring high speed processing is switched to a state requiring high speed processing, namely, when the instruction 2 such as “Switch MPU1 to MPU2” for switching the first microprocessor unit to the second microprocessor unit as shown in FIG. 20 appears on a given instruction stream, the first microprocessor unit 102 first saves data stored in the memory section (first memory section) 103 of the first microprocessor unit 102 in the external memory section 112 through the bus 110 and the bus 111 in MPU1 data saving processing S1 as shown in FIG. 2.

The MPU1 data saving processing S1 is executed in accordance with an instruction issued by the first microprocessor unit 102 for saving the data of the memory section 103 in the external memory section 112. This instruction is a store instruction of the first microprocessor unit 102.

Next, in MPU2 power supplying processing S2, the first microprocessor unit 102 makes the power control section 115 control power to be supplied to the second microprocessor unit 106 having been disconnected from power. The MPU2 power supplying processing S2 is executed by the first microprocessor unit 102 issuing an instruction for making the power control section 115 supply power to the second microprocessor unit 106. In many cases, this instruction is executed by the first microprocessor unit 102 making the power control section 115 set data flag, for supplying power to the second microprocessor unit 106, of a control register of the power control section 115.

Next, in MPU1 power disconnecting processing S3, the first microprocessor unit 102 makes the power control section 115 stop supplying power to the first microprocessor unit 102.

The MPU1 power disconnecting processing S3 is realized by the first microprocessor unit 102 issuing an instruction for making the power control section 115 disconnect the first microprocessor unit 102 from power. In many cases, this instruction is executed by the first microprocessor unit 102 making the power control section 115 set data flag, for disconnecting the first microprocessor unit 102 from power, of the control register of the power control section 115.

Ultimately, in MPU2 data storing processing S4, the second microprocessor unit 106 stores the data having been saved in the external memory section 112 in the memory section (second memory section) 107 of the second microprocessor unit 106 through the bus 111 and the bus 110.

The MPU2 data storing processing S4 is executed by the second microprocessor unit 106 in response to an instruction for storing the data of the first microprocessor unit 102 having been saved in the external memory section 112 in the memory section 107 of the second microprocessor unit 106. This instruction is executed in accordance with a load instruction of the second microprocessor unit 106.

FIG. 3 is a flowchart for explaining a power control method employed when the unit used for the operation control is switched from the second microprocessor unit 106 to the first microprocessor unit 102.

It is first assumed that power is supplied to the second microprocessor unit 106 from the first power supply system 113 and that the first microprocessor unit 102 is disconnected from power. When this state requiring high speed processing is switched to the state not requiring high speed processing, namely, when the instruction 4 such as “Switch MPU2 to MPU1” for switching the second microprocessor unit to the first microprocessor unit shown in FIG. 20 appears on a given instruction stream, the second microprocessor unit 106 first saves data stored in the memory section (second memory section) 107 of the second microprocessor unit 106 in the external memory section 112 through the bus 110 and the bus 111 in MPU2 data saving processing S11 as shown in FIG. 3.

The MPU2 data saving processing S11 is executed in accordance with an instruction issued by the second microprocessor unit 106 for saving the data of the memory section 107 in the external memory section 112. This instruction is a store instruction of the second microprocessor unit 106.

Next, in MPU1 power supplying processing S12, the second microprocessor unit 106 makes the power control section 115 control power to be supplied to the first microprocessor unit 102 having been disconnected from power. The MPU1 power supplying processing S12 is executed by the second microprocessor unit 106 issuing an instruction for making the power control section 115 supply power to the first microprocessor unit 102. In many cases, this instruction is executed by the second microprocessor unit 106 making the power control section 115 set data flag, for supplying power to the first microprocessor unit 102, of a control register of the power control section 115.

Next, in MPU2 power disconnecting processing S13, the second microprocessor unit 106 makes the power control section 115 stop supplying power to the second microprocessor unit 106.

The MPU2 power disconnecting processing S13 is realized by the second microprocessor unit 106 issuing an instruction for making the power control section 115 disconnect the second microprocessor unit 106 from power. In many cases, this instruction is executed by the second microprocessor unit 106 making the power control section 115 set data flag, for disconnecting the second microprocessor unit 106 from power, of the control register of the power control section 115.

Ultimately, in MPU1 data storing processing S14, the second microprocessor unit 106 stores the data having been saved in the external memory section 112 in the memory section (first memory section) 103 of the first microprocessor unit 102 through the bus 111 and the bus 110.

The MPU1 data storing processing S14 is executed by the first microprocessor unit 102 in response to an instruction for storing the data of the second microprocessor unit 106 having been saved in the external memory section 112 in the memory section 103 of the first microprocessor unit 102. This instruction is executed in accordance with a load instruction of the first microprocessor unit 102.

As described so far, in the case where a given program of this embodiment includes a program not requiring high speed processing (hereinafter referred to as the first program) and a program requiring high speed processing (hereinafter referred to as the second program), the switching instruction (the first or second MPU switching instruction) is inserted in a position where the first and second programs having different operation speeds are switched, so as to switch a currently used microprocessor to another microprocessor according to the operation speed necessary for the first or second program to be processed. In other words, at the issue of the processor switching instruction, the first microprocessor unit constructed from the transistors having the first threshold voltage set to be low, which cannot perform high speed processing but can be operated with a low leakage current, and the second microprocessor unit constructed from the transistors having the second threshold voltage set to be high, which does not have a low leakage current characteristic but is capable of high speed processing, are switched. Thus, high speed processing and low power consumption processing can be properly performed in accordance with necessity.

The two microprocessor units respectively constructed from the transistors having two different threshold voltages are used in the semiconductor integrated circuit device of this embodiment. But this embodiment is easily applicable to a device including a plurality of microprocessor units respectively constructed from transistors having a plurality of different threshold voltages, namely, a device in which a currently used microprocessor unit is switched to another given microprocessor unit included therein in a manner similar to this embodiment in accordance with a load of an instruction (a given instruction stream) to be processed when the load is changed.

Embodiment 2

Embodiment 2 of the invention will now be described with reference to the drawings.

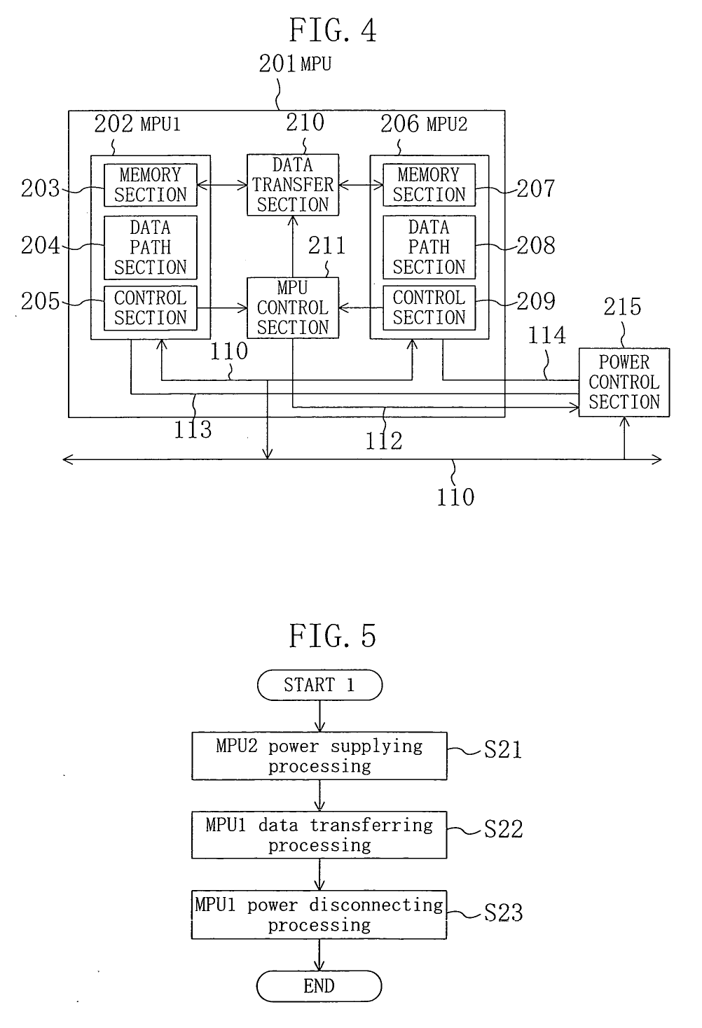

FIG. 4 shows an example of the architecture of a semiconductor integrated circuit device of this embodiment. The semiconductor integrated circuit device is constructed from transistors having three kinds of threshold voltages, that is, a first threshold voltage, a second threshold voltage and a third threshold voltage. A reference numeral 201 denotes a microprocessor unit, which includes two microprocessor units, that is, a first microprocessor unit 202 and a second microprocessor unit 206. These microprocessor units respectively include memory sections 203 and 207, data path sections 204 and 208 and control sections 205 and 209. The control sections 205 and 209 respectively control the operations of the first microprocessor unit 202 and the second microprocessor unit 206 in accordance with instructions to be processed. The memory sections 203 and 207 are respectively constructed from registers and memories for storing data resulting from control and operation of the microprocessor units. A reference numeral 210 denotes a data transfer circuit, which is connected between the memory section 203 of the first microprocessor unit 202 and the memory section 207 of the second microprocessor unit 206 for performing data transfer between these memory sections. A reference numeral 211 denotes an MPU control section, which executes control of power supply to be supplied to power supply systems for the first microprocessor unit 202 and the second microprocessor unit 206 by supplying control signals to a power control section 215 under control by the first microprocessor unit 202 and the second microprocessor unit 206, and also controls the data transfer circuit 210 for controlling the data transfer between the memory sections 203 and 207.

Furthermore, in FIG. 4, the first microprocessor unit 202 is connected to a first power supply system 113 and the second microprocessor unit 206 is connected to a second power supply system 114. The data transfer circuit 210 and the MPU control section 211 are directly connected to a power supply for always supplying power. Although not shown in the drawing, this directly connected power supply is designated as a third power supply system. The first microprocessor unit 202 is constructed from transistors having the first threshold voltage, and the second microprocessor unit 206 is constructed from transistors having the second threshold voltage. The data transfer circuit 210 and the MPU control section 211 connected to the third power supply system are constructed from transistors having the third threshold voltage, and the data transfer circuit 210 is connected to the memory section 203 of the first microprocessor unit 202 and the memory section 207 of the second microprocessor unit 206. Also, the MPU control section 211 is connected to the control section 205 of the first microprocessor unit 202 and the control section 209 of the second microprocessor unit 206.

First, referring to FIG. 5, a method for power control performed by the first microprocessor unit 202 will be described. FIG. 5 is a flowchart for explaining a power control method employed when a unit used for the operation control is switched from the first microprocessor unit 202 to the second microprocessor unit 206. As shown in FIG. 5, when the state not requiring high speed processing is switched to the state requiring high speed processing, namely, when the instruction 2 such as “Switch MPU1 to MPU2” for switching the first microprocessor unit to the second microprocessor unit shown in FIG. 20 appears on a given instruction stream, the first microprocessor unit 202 first supplies power to the second microprocessor unit 206 having been disconnected from power through the control by the power control section 215 in MPU2 power supplying processing S21. The MPU2 power supplying processing S21 is executed by the first microprocessor unit 202 issuing an instruction for making the power control section 215 supply power to the second microprocessor unit 206. In many cases, this instruction is executed by the first microprocessor unit 202 making the power control section 215 set data flag, for supplying power to the second microprocessor unit 206, of a control register of the power control section 215.

Next, in MPU1 data transferring processing S22, data stored in the memory section 203 of the first microprocessor unit 202 is transferred to the data transfer circuit 210 and then stored in the memory section 207 of the second microprocessor unit 206. Ultimately, when the data transfer is completed, the flow proceeds to MPU1 power disconnecting processing S23, in which the power control section 215 is instructed to change power supply to the first microprocessor unit 202 and the power supply system 113 is turned off.

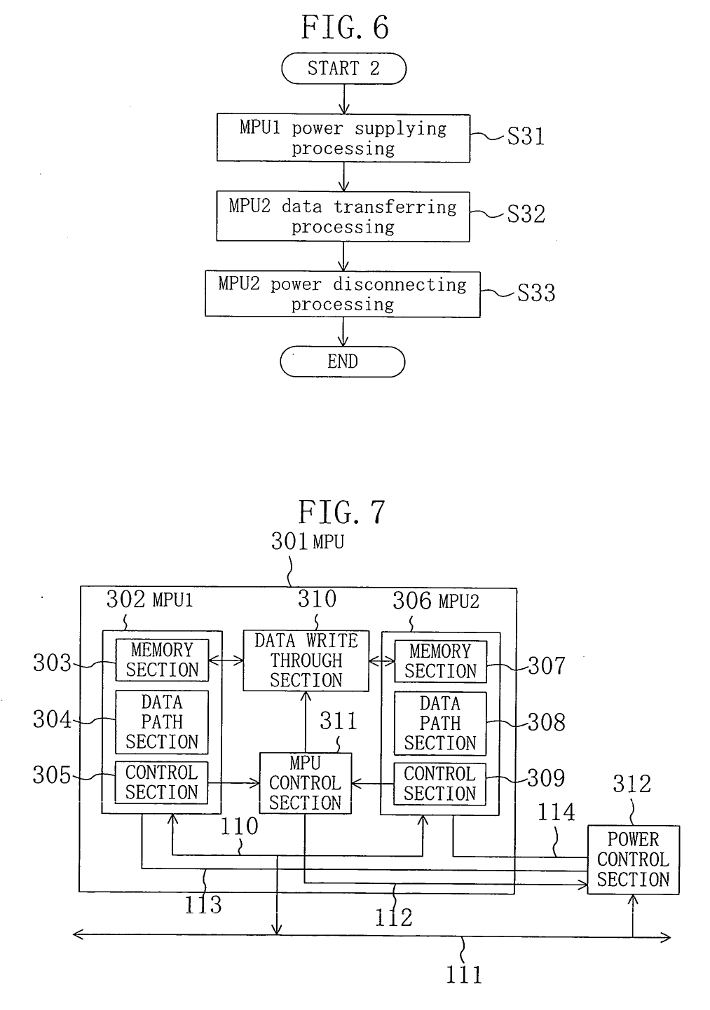

Next, FIG. 6 is a flowchart for explaining a power control method employed when the unit used for the operation control is switched from the second microprocessor unit 206 to the first microprocessor unit 202.

When the state requiring high speed processing is switched to the state not requiring high speed processing, namely, when the instruction 4 such as “Switch MPU2 to MPU1” for switching the second microprocessor unit to the first microprocessor unit shown in FIG. 20 appears on a given instruction stream, the second microprocessor unit 206 first supplies power to the first microprocessor unit 202 having been disconnected from power through the control by the power control section 215 in MPU1 power supplying processing S31. Next, in MPU2 data transferring processing S32, data stored in the memory section 207 of the second microprocessor unit 206 is transferred to the data transfer circuit 210 and then stored in the memory section 203 of the first microprocessor unit 202. Ultimately, in MPU2 power disconnecting processing S33, the microprocessor unit 201 instructs the power control section 215 to stop power supply to the second microprocessor unit 206.

The first microprocessor unit 202 is constructed from the transistors having the high threshold voltage, and therefore, no large leakage current is caused in the first microprocessor unit 202. In the mode where the first microprocessor unit 202 is operated, since the power supply to the second microprocessor unit 206 constructed from the transistors having the low threshold voltage is stopped, no leakage current is caused also in the second microprocessor unit 206. Thus, a leakage current can be suppressed to a substantially negligible level in the whole microprocessor unit 201. In the mode where the second microprocessor unit 206 is operated, since the working portion is constructed from the transistors having the low threshold voltage, a sufficiently high operation speed can be attained even under application of a low power supply voltage.

According to this embodiment, since the data transfer between the memory sections of the first microprocessor unit 202 and the second microprocessor unit 206 is performed through the data transfer circuit 210, the switching of these microprocessor units can be controlled without considering an occupation period of the buses. Also, since the bit width of the data transfer circuit 210 can be variable, a transition period between the modes can be shortened by increasing the bit width.

The two microprocessor units respectively constructed from the transistors having two different threshold voltages are used in the semiconductor integrated circuit device of this embodiment. But this embodiment is easily applicable to a device including a plurality of microprocessor units respectively constructed from transistors having a plurality of different threshold voltages, namely, a device in which a currently used microprocessor unit is switched to another given microprocessor unit included therein in a manner similar to this embodiment in accordance with a load of an instruction (a given instruction stream) to be processed when the load is changed.

Embodiment 3

Embodiment 3 of the invention will now be described with reference to the drawings.

FIG. 7 shows an example of the architecture of a semiconductor integrated circuit device of this embodiment. A reference numeral 301 denotes a microprocessor unit. Reference numerals 302 and 306 respectively denote a first microprocessor unit and a second microprocessor unit, which respectively include memory sections 303 and 307, data path sections 304 and 308 and control sections 305 and 309. A reference numeral 310 denotes a data write through circuit, which is connected to the memory section 303 of the first microprocessor unit 302 and the memory section 307 of the second microprocessor unit 306 for transferring data stored in one of the memory sections to the other. The first microprocessor unit 302 is connected to a power control section 312 for controlling power supply through a first power supply system 113, and similarly, the second microprocessor unit 306 is connected to the power control section 312 through a second power supply system 114. A reference numeral 311 denotes an MPU control section, which controls the data transfer operation of the data write through circuit 310 on the basis of control by the control section 305 of the first microprocessor unit 302 and the control section 309 of the second microprocessor unit 306, and sends, to the power control section 312, a control signal on the basis of the control by the control sections 305 and 309 for executing the power connection/disconnection of the power supply systems of the first microprocessor unit 302 and the second microprocessor unit 306.

At this point, the control signal sent from the MPU control section 311 to the data write through circuit 310 on the basis of the control by the first microprocessor unit 302 and the second microprocessor unit 306 is used for controlling the data transfer so that every time one of the memory section 303 and the memory section 307 of the first microprocessor unit 302 and the second microprocessor unit 306 is updated, the updated data is sent to the other memory section.

Furthermore, the data write through circuit 310 and the MPU control section 311 are directly connected to a power supply for always supplying power. Also, the memory sections 303 and 307 are directly connected to a power supply for always supplying power so that the updated data can be received. The first microprocessor unit 302 is constructed from transistors having a first threshold voltage and the second microprocessor unit 306 is constructed from transistors having a second threshold voltage lower than the first threshold voltage. The data write through circuit 310 and the MPU control section 311 are constructed from transistors having a third threshold voltage.

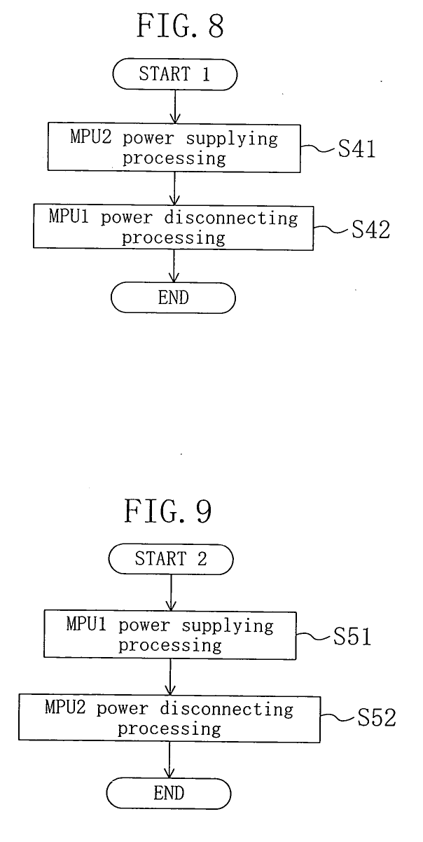

FIG. 8 is a flowchart for explaining a power control method employed when a unit used for the operation control is switched from the first microprocessor unit 302 to the second microprocessor unit 306. When the state not requiring high speed processing is switched to the state requiring high speed processing, namely, when the instruction 2 such as “Switch MPU1 to MPU2” for switching the first microprocessor unit to the second microprocessor unit shown in FIG. 20 appears on a given instruction stream, the first microprocessor unit 302 first supplies power to the second microprocessor unit 306 having been disconnected from power through the control by the power control section 312 in MPU2 power supplying processing S41. In the MPU2 power supplying processing S41, the first microprocessor unit 302 issues an instruction for making the power control section 312 supply power to the second microprocessor unit 306. In many cases, this instruction is executed by the first microprocessor unit 302 making the power control section 312 set data to a bit, for supplying power to the second microprocessor unit 306, of a control register of the power control section 312. Next, the flow proceeds to MPU1 power disconnecting processing S42, in which the power control section 312 is instructed to change power supply to the first microprocessor unit 302 and the power supply system 113 is turned off. At this point, there is no need to save data for switching the microprocessor unit because data stored in the memory section 303 of the first microprocessor unit 302 is always transferred through the data write through circuit 310 to the memory section 307 of the second microprocessor unit 306 every time it is updated.

FIG. 9 is a flowchart for explaining a power control method employed when the unit used for the operation control is switched from the second microprocessor unit 306 to the first microprocessor unit 302. When the state requiring high speed processing is switched to the state not requiring high speed processing, namely, when the instruction 4 such as “Switch MPU2 to MPU1” for switching the second microprocessor unit to the first microprocessor unit shown in FIG. 20 appears on a given instruction stream, the power control section 312 first supplies power to the first microprocessor unit 302 having been disconnected from power in MPU1 power supplying processing S51 as shown in FIG. 9.

Next, the flow proceeds to MPU2 power disconnecting processing S52, in which the power control section 312 is instructed to change power supply to the first microprocessor unit 302 and the power supply system 114 is turned off. At this point, there is no need to save data for switching the microprocessor unit because data stored in the memory section 307 of the second microprocessor unit 306 is always transferred through the data write through circuit 310 to the memory section 303 of the first microprocessor unit 302 every time it is updated.

The first microprocessor unit 302 is constructed from the transistors having a high threshold voltage, and therefore, no large leakage current is caused in the first microprocessor unit 302. In the mode where the first microprocessor unit 302 is operated, since the power supply to the second microprocessor unit 306 constructed from the transistors having a low threshold voltage is stopped, no leakage current is caused also in the second microprocessor unit 306. Thus, a leakage current can be suppressed to a substantially negligible level in the whole microprocessor unit 301. In the mode where the second microprocessor unit 306 is operated, since the working portion is constructed from the transistors having the low threshold voltage, a sufficiently high operation speed can be attained even under application of a low power supply voltage.

According to this embodiment, since the data transfer between the memory sections 303 and 307 is performed through the data write through circuit 310 with data identity always kept every time the memory sections 303 and 306 are updated, the switching of the microprocessor units can be controlled without providing a new data transfer period. Also, since the bit width of the data write through circuit 310 can be variable, a transition period between the modes can be shortened by increasing the bit width.

In this embodiment, since the power is always supplied to the memory sections 303 and 307, the data transfer period can be minimized, but one power supply system can be shared with the first and second microprocessor units 302 and 306, respectively. In this case, data can be transferred to the data write through circuit 310 with the data identity kept, but data write in the memory section of a disconnected one of the microprocessor units is performed after changing the power supply system, and hence, it is necessary to provide a data transfer period at the time of switching the power supply system. However, since both the first and second microprocessor units can be controlled by one and the same power supply system, the number of design steps for a power supply line and the like can be reduced.

The two microprocessor units respectively constructed from the transistors having two different threshold voltages are used in the semiconductor integrated circuit device of this embodiment. But this embodiment is easily applicable to a device including a plurality of microprocessor units respectively constructed from transistors having a plurality of different threshold voltages, namely, a device in which a currently used microprocessor unit is switched to another given microprocessor unit included therein in a manner similar to this embodiment in accordance with a load of an instruction (a given instruction stream) to be processed when the load is changed.

Embodiment 4

Embodiment 4 of the invention will now be described with reference to the drawings.

FIG. 10 shows an example of the architecture of a semiconductor integrated circuit device of this embodiment. A reference numeral 401 denotes a semiconductor integrated circuit device. Reference numerals 402 and 405 respectively denote a first microprocessor unit and a second microprocessor unit, which respectively include data path sections 403 and 406 and control sections 404 and 407. A reference numeral 408 denotes a memory section, which is connected to and shared by the first microprocessor unit 402 and the second microprocessor unit 405. The first microprocessor unit 402 is connected to a power control section 410 for controlling power supply through a first power supply system 113, and similarly, the second microprocessor unit 405 is connected to the power control section 410 through a second power supply system 114. A reference numeral 409 denotes an MPU control section, which controls a data storing operation of the memory section 408 on the basis of control by the control section 404 of the first microprocessor unit 402 and the control section 407 of the second microprocessor unit 405, and sends, to the power control section 410, a control signal on the basis of the control by the control sections 404 and 407 for executing the power connection/disconnection of the power supply systems for the first microprocessor unit 402 and the second microprocessor unit 405.

The memory section 408 and the MPU control section 409 shared by the first microprocessor unit 402 and the second microprocessor unit 405 are directly connected to a power supply for always supplying power. The first microprocessor unit 402 is constructed from transistors having a first threshold voltage and the second microprocessor unit 405 is constructed from transistors having a second threshold voltage.

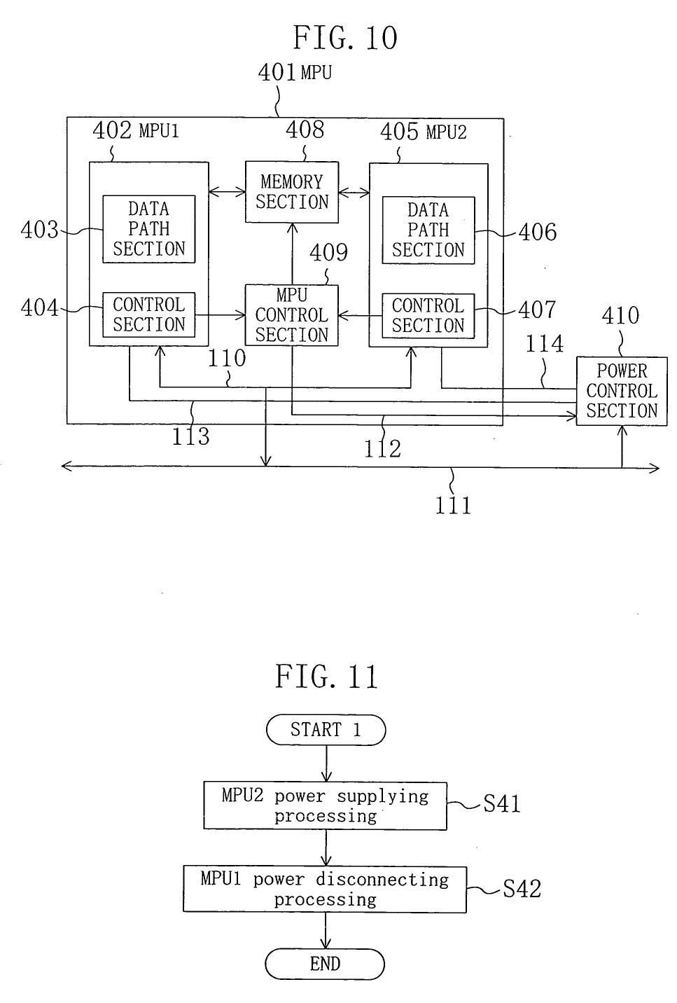

FIG. 11 is a flowchart for explaining a power control method employed when a unit used for the operation control is switched from the first microprocessor unit 402 to the second microprocessor unit 405.

When the state not requiring high speed processing is switched to the state requiring high speed processing, namely, when the instruction 2 such as “Switch MPU1 to MPU2” for switching the first microprocessor unit to the second microprocessor unit shown in FIG. 20 appears on a given instruction stream, the first microprocessor unit 402 first supplies power to the second microprocessor unit 405 having been disconnected from power through the control by the power control section 410 in MPU2 power supplying processing S41. In the MPU2 power supplying processing S41, the first microprocessor unit 402 issues an instruction for making the power control section 410 supply power to the second microprocessor unit 405, and the power is supplied by the power control section 410. In many cases, this instruction is executed by the first microprocessor unit 402 making the power control section 410 set data to a bit, for supplying power to the second microprocessor unit 405, of a control register of the power control section 410.

Next, the flow proceeds to MPU1 power disconnecting processing S42, in which the power control section 410 is instructed to change power supply to the first microprocessor unit 402 and the power supply system 113 is turned off. In this embodiment, there is no need to save data for switching the microprocessor unit because the memory section 408 is shared by the first microprocessor unit 402 and the second microprocessor unit 405.

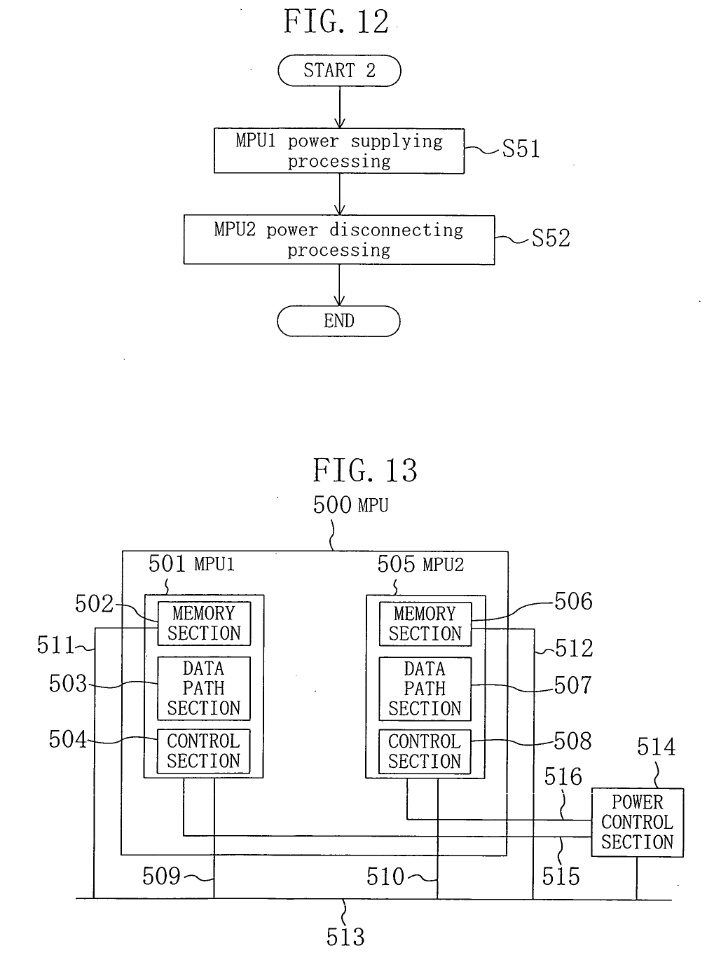

FIG. 12 is a flowchart for explaining a power control method employed when the unit used for the operation control is switched from the second microprocessor unit 405 to the first microprocessor unit 402.

When the state requiring high speed processing is switched to the state not requiring high speed processing, namely, when the instruction 4 such as “Switch MPU2 to MPU1” for switching the second microprocessor unit to the first microprocessor unit shown in FIG. 20 appears on a given instruction stream, the second microprocessor unit 405 first supplies power to the first microprocessor unit 402 having been disconnected from power through the control by the power control section 410 in MPU1 power supplying processing S51 as shown in FIG. 12. Next, the flow proceeds to MPU2 power disconnecting processing S52, in which the power control section 410 is instructed to change power supply to the first microprocessor unit 402 and the power supply system 114 is turned off.

The first microprocessor unit 402 is constructed from the transistors having a high threshold voltage, and therefore, no large leakage current is caused in the first microprocessor unit 402. In the mode where the first microprocessor unit 402 is operated, since the power supply to the second microprocessor unit 405 constructed from the transistors having a low threshold voltage is stopped, no leakage current is caused also in the second microprocessor unit 405. Thus, a leakage current can be suppressed to a substantially negligible level in the whole microprocessor unit 401. The switching to the general operation mode is executed in the reverse manner by switching the power supply, and thus, the mode can be switched to the state where a high speed operation can be performed. Since the memory section 408 is shared by the first and second microprocessor units 402 and 405, there is no need to provide a period for resetting or saving data at the time of switching of the first and second microprocessor units 402 and 405, and hence, the switching can be rapidly carried out.

In this embodiment, the memory section 408 and the MPU control section 409 are respectively constructed from transistors having a third threshold voltage. In the case where the third threshold voltage is set to be equal to the first threshold voltage of the first microprocessor unit 402, the number of kinds of controls for the threshold voltages can be suppressed to two. Therefore, the circuit operation speed can be increased and high speed performance can be attained within the scope of a given process architecture. Alternatively, in the case where the third threshold voltage is set to be equal to the second threshold voltage of the second microprocessor unit 405, a leakage current caused in a circuit portion always supplied with power can be reduced. Further alternatively, in the case where the third threshold voltage is set to be equal to neither the first threshold voltage of the first microprocessor unit 402 nor the second threshold voltage of the second microprocessor unit 405 but is optimally set, although a design time is increased due to the increase of the kinds of threshold voltages, an optimally balanced point between a high operation speed and a low leakage current can be selected, resulting in improving the total performance of the semiconductor integrated circuit device.

Embodiment 5

Embodiment 5 of the invention will now be described with reference to the drawings.

FIG. 13 shows an example of the architecture of a semiconductor integrated circuit device of this embodiment.

The semiconductor integrated circuit device of FIG. 13 is a framework generally designated as an LSI or a chip, and is integrated on one silicon substrate or includes a plurality of silicon substrates mounted on one package. A reference numeral 500 denotes a microprocessor unit, which includes two microprocessor units, that is, a first microprocessor unit 501 and a second microprocessor unit 505. The first microprocessor unit 501 is constructed from transistors having a first threshold voltage, and the second microprocessor unit 505 is constructed from transistors having a second threshold voltage, and the first microprocessor unit 501 and the second microprocessor unit 505 are instruction set compatible with each other and have functions of both a master operation and a slave operation.

The first microprocessor unit 501 includes a memory section 502, a data path section 503 and a control section 504. The memory section 502 is constructed from registers and memories for storing data resulting from control and operation of the first microprocessor unit 501. The memory section 502 has interface with an external device for writing data in and reading data from the outside of the first microprocessor unit 501.

The data path section 503 executes operation processing within the first microprocessor unit 501. The control section 504 controls the operation of the first microprocessor unit 501 in accordance with an instruction to be processed.

Similar to the first microprocessor unit 501, the second microprocessor unit 505 includes a memory section 506, a data path section 507 and a control section 508. The memory section 506 is constructed from registers and memories for storing data resulting from control and operation of the second microprocessor unit 505. The memory section 506 has interface with an external device for writing data in and reading data from the outside of the second microprocessor unit 505. The data path section 507 executes operation processing within the second microprocessor unit 505. The control section 508 controls the operation of the second microprocessor unit 505 in accordance with an instruction to be processed.

Reference numerals 509, 510, 511, 512 and 513 denote buses for transferring data and instructions, which connect the first microprocessor unit 501, the second microprocessor unit 505, the memory section 502 of the first microprocessor unit 501, the memory section 506 of the second microprocessor unit 505 and a power control section 514 to one another. In addition, a variety of other circuits are connected to the buses.

The power control section 514 controls the power supply to be supplied to the first microprocessor unit 501 and the second microprocessor unit 505 in accordance with instructions supplied from the first microprocessor unit 501 and the second microprocessor unit 505.

Power supply systems 515 and 516 are controlled by the power control section 514, and are respectively connected to power inputs of the first microprocessor unit 501 and the second microprocessor unit 505.

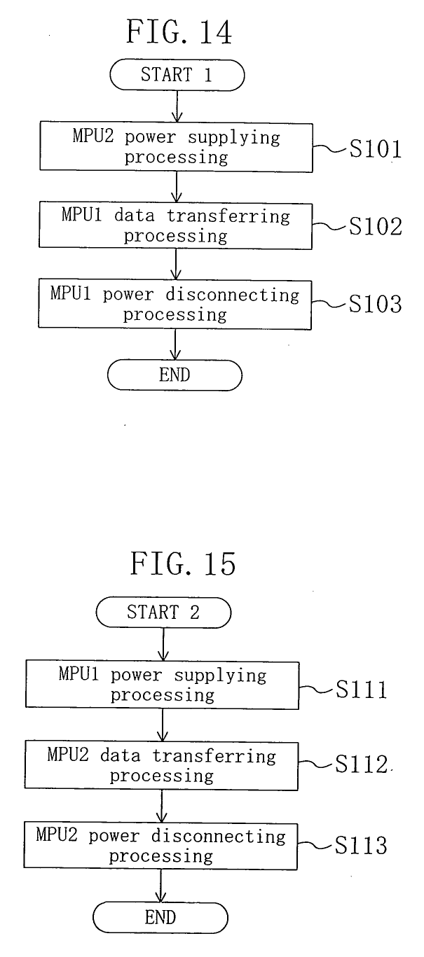

Next, a method for power control performed by the microprocessor unit 500 will be described with reference to FIGS. 14 and 15.

FIG. 14 is a flowchart for explaining a power control method employed when a unit used for operation control is switched from the first microprocessor unit 501 to the second microprocessor unit 505.

It is first assumed that power is supplied to the first microprocessor unit 501 and that the second microprocessor unit 505 is disconnected from power.

When this state not requiring high speed processing is switched to a state requiring high speed processing, namely, when the instruction 2 such as “Switch MPU1 to MPU2” for switching the first microprocessor unit 501 to the second microprocessor unit 505 shown in FIG. 20 appears on a given instruction stream, the first microprocessor unit 501 first supplies power to the second microprocessor unit 106 having been disconnected from power through control by the power control section 514 in MPU2 power supplying processing S101 as shown in FIG. 14.

The MPU2 power supplying processing S101 is executed by the first microprocessor unit 501 making the power control section 514 execute an instruction for supplying power to the second microprocessor unit 505. In many cases, this instruction is executed by the first microprocessor unit 501 making the power control section 514 set data flag, for supplying power to the second microprocessor unit 505, of a control register of the power control section 514.

Next, in MPU1 data transferring processing S102, data stored in the memory section 502 of the first microprocessor unit 501 is transferred to the memory section 506 of the second microprocessor unit 505 in response to a data transfer instruction issued by the first microprocessor unit 501. This instruction is executed in accordance with a store instruction of the first microprocessor unit 501.

Ultimately, in MPU1 power disconnecting processing S103, the power control section 514 stops supplying power to the first microprocessor unit 501.

The MPU1 power disconnecting processing S103 is realized by the first microprocessor unit 501 making the power control section 514 execute an instruction for disconnecting the first microprocessor unit 501 from power. In many cases, this instruction is executed by the first microprocessor unit 501 making the power control section 514 set data flag, for disconnecting the first microprocessor unit 501 from power, of the control register of the power control section 514.

FIG. 15 is a flowchart for explaining a power control method employed when the unit used for the operation control is switched from the second microprocessor unit 505 to the first microprocessor unit 501.

It is first assumed that power is supplied to the second microprocessor unit 505 and that the first microprocessor unit 501 is disconnected from power.

When this state requiring high speed processing is switched to the state not requiring high speed processing, namely, when the instruction 4 such as “Switch MPU2 to MPU1” for switching the second microprocessor unit 505 to the first microprocessor unit 501 shown in FIG. 20 appears on a given instruction stream, the second microprocessor unit 505 first supplies power to the first microprocessor unit 501 having been disconnected from power in MPU1 power supplying processing S111 as shown in FIG. 15.

The MPU1 power supplying processing S111 is executed by the second microprocessor unit 505 making the power control section 514 execute an instruction for supplying power to the first microprocessor unit 501. In many cases, this instruction is executed by the second microprocessor unit 505 making the power control section 514 set data to a bit, for supplying power to the first microprocessor unit 501, of a control register of the power control section 514.

Next, in MPU2 data transferring processing S112, data stored in the memory section 512 of the second microprocessor unit 505 is transferred to the memory section 502 of the first microprocessor unit 501 in response to a data transfer instruction issued by the second microprocessor unit 505. This instruction is executed by a store instruction of the second microprocessor unit 505.

Ultimately, in MPU2 power disconnecting processing S113, the power control section 514 stops supplying power to the second microprocessor unit 505.

The MPU2 power disconnecting processing S113 is realized by the second microprocessor unit 505 making the power control section 514 execute an instruction for disconnecting the second microprocessor unit 505 from power. In many cases, this instruction is executed by the second microprocessor unit 505 making the power control section 514 set data to a bit, for disconnecting the second microprocessor unit 505 from power, of the control register of the power control section 514.

As described so far, the first microprocessor unit 501 constructed from the transistors having the first threshold voltage and the second microprocessor unit 505 constructed from the transistors having the second threshold voltage are switched in accordance with the characteristic of a program to be processed. Thus, a low power consumption operation can be realized. In addition, there is no need to provide memory means outside the first microprocessor unit 501 and the second microprocessor unit 505, and the switching can be performed through procedures in smaller number than in Embodiment 1.

The two microprocessor units respectively constructed from the transistors having two different threshold voltages are used in the semiconductor integrated circuit device of this embodiment. But this embodiment is easily applicable to a device including a plurality of microprocessor units respectively constructed from transistors having a plurality of different threshold voltages, namely, a device in which a currently used microprocessor unit is switched to another given microprocessor unit included therein in a manner similar to this embodiment in accordance with a load of an instruction (a given instruction stream) to be processed when the load is changed.

Embodiment 6

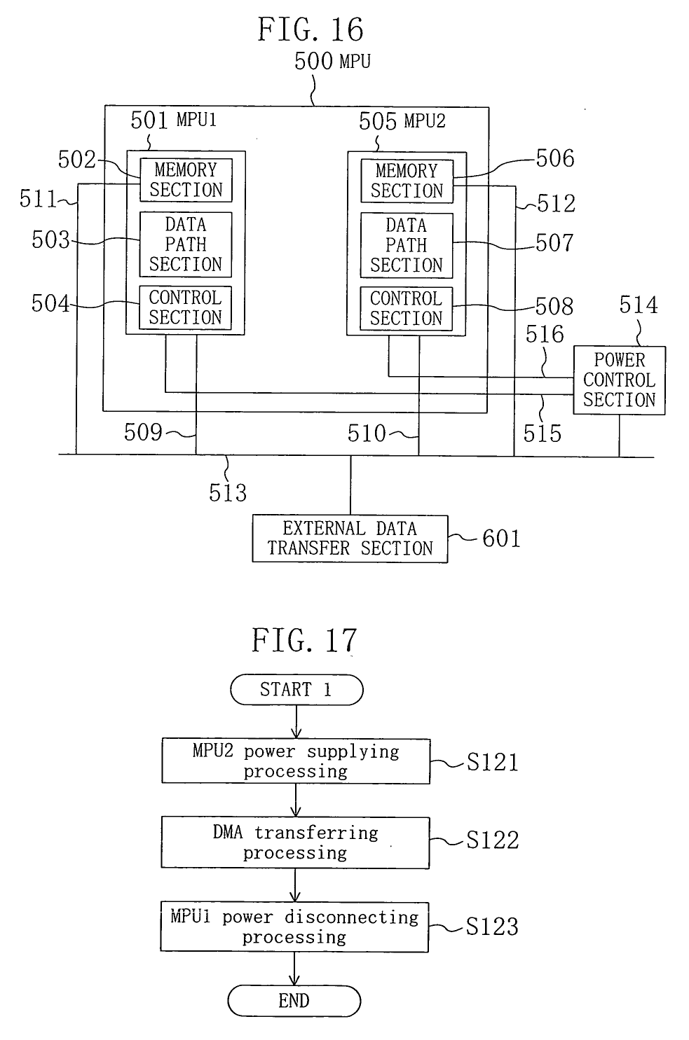

Embodiment 6 of the invention will now be described with reference to FIG. 16.

In FIG. 16, like reference numerals are used to refer to like elements shown in FIG. 13 and hence the description is herein omitted. An external data transfer circuit 601 has a function to read data from and write data in a circuit connected to a bus 513. An example of the circuit having such a function is a direct memory access controller.

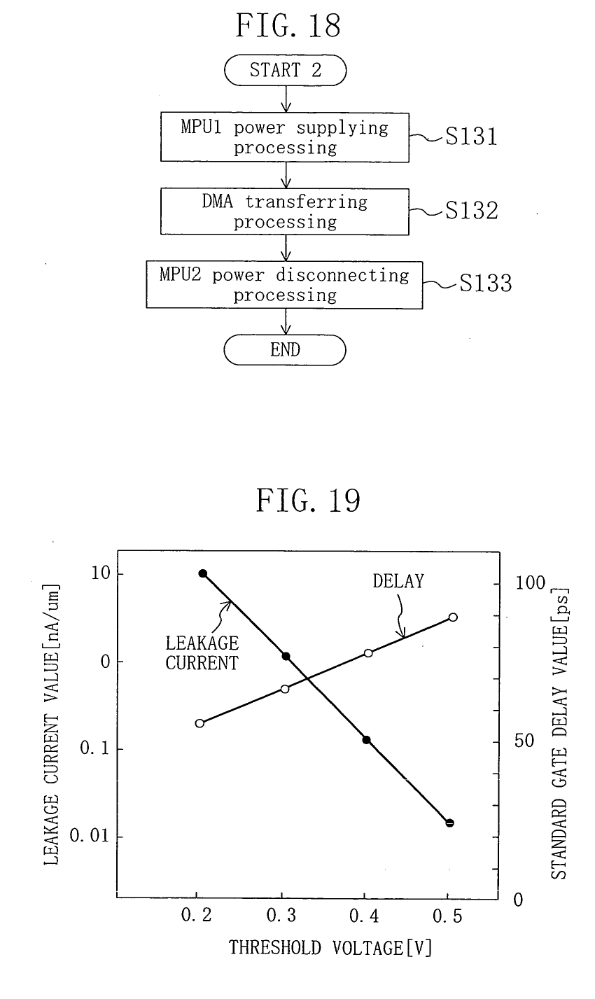

Next, a method for power control performed by the microprocessor unit 500 of this embodiment will be described with reference to FIGS. 17 and 18.

FIG. 17 is a flowchart for explaining a power control method employed when a unit used for operation control is switched from the first microprocessor unit 501 to the second microprocessor unit 505. It is first assumed that power is supplied to the first microprocessor unit 501 and that the second microprocessor unit 505 is disconnected from power.

When this state not requiring high speed processing is switched to a state requiring high speed processing, namely, when the instruction 2 such as “Switch MPU1 to MPU2” for switching the first microprocessor unit 501 to the second microprocessor unit 505 shown in FIG. 20 appears on a given instruction stream, the first microprocessor unit 501 first supplies power to the second microprocessor unit 505 having been disconnected from power through control by the power control section 514 in MPU2 power supplying processing S121 as shown in FIG. 17.

The MPU2 power supplying processing S121 is executed by the first microprocessor unit 501 making the power control section 514 execute an instruction for supplying power to the second microprocessor unit 505. In many cases, this instruction is executed by the first microprocessor unit 501 making the power control section 514 set data flag, for supplying power to the second microprocessor unit 505, of a control register of the power control section 514.

Next, in DMA transferring processing S122, the first microprocessor unit 501 instructs the external data transfer circuit 601 to transfer data stored in the memory section 502 of the first microprocessor unit 501 to the memory section 506 of the second microprocessor unit 505.

Ultimately, in MPU1 power disconnecting processing S123, the first microprocessor unit 501 makes the power control section 514 stop supplying power to the first microprocessor unit 501.

The MPU1 power disconnecting processing S123 is realized by the first microprocessor unit 501 issuing an instruction for making the power control section 514 disconnect the first microprocessor unit 501 from power. In many cases, this instruction is executed by the first microprocessor unit 501 making the power control section 514 set data to a bit, for disconnecting the first microprocessor unit 501 from power, of the control register of the power control section 514.

FIG. 18 is a flowchart for explaining a power control method employed when the unit used for the operation control is switched from the second microprocessor unit 505 to the first microprocessor unit 501. It is first assumed that power is supplied to the second microprocessor unit 505 and that the first microprocessor unit 501 is disconnected from power.

When this state requiring high speed processing is switched to the state not requiring high speed processing, namely, when the instruction 4 such as “Switch MPU2 to MPU1” for switching the second microprocessor unit 505 to the first microprocessor unit 501 shown in FIG. 20 appears on a given instruction stream, the second microprocessor unit 505 first supplies power to the first microprocessor unit 501 having been disconnected from power in MPU1 power supplying processing S131 as shown in FIG. 18.

The MPU1 power supplying processing S131 is realized by the second microprocessor unit 505 issuing an instruction for making the power control section 514 supply power to the first microprocessor unit 501. In many cases, this instruction is executed by the second microprocessor unit 505 making the power control section 514 set data to a bit, for supplying power to the first microprocessor unit 501, of a control register of the power control section 514.

Next, in DMA transferring processing S132, the second microprocessor unit 505 issues an instruction to the external data transfer circuit 601 for transferring data stored in the memory section 506 of the second microprocessor unit 505 to the memory section 502 of the first microprocessor unit 501.

Ultimately, in MPU2 power disconnecting processing S133, the second microprocessor unit 505 makes the power control section 514 stop supplying power to the second microprocessor unit 505.

The MPU2 power disconnecting processing S133 is realized by the second microprocessor unit 505 issuing an instruction for making the power control section 514 disconnect the second microprocessor unit 505 from power. In many cases, this instruction is executed by the second microprocessor unit 505 making the power control section 514 set data to a bit, for disconnecting the second microprocessor unit 505 from power, of the control register of the power control section 514.

As described so far, the first microprocessor unit 501 constructed from the transistors having the first threshold voltage and the second microprocessor unit 505 constructed from the transistors having the second threshold voltage are switched in accordance with the characteristic of a program to be processed. Thus, a low power consumption operation can be realized. In addition, there is no need to provide memory means outside the first microprocessor unit 501 and the second microprocessor unit 505, and the switching can be performed through procedures in smaller number than in Embodiment 1. Furthermore, the data transfer between the memory sections 502 and 506 can be performed by the external data transfer circuit 601 through independent processing.

The two microprocessor units respectively constructed from the transistors having two different threshold voltages are used in the semiconductor integrated circuit device of this embodiment. But this embodiment is easily applicable to a device including a plurality of microprocessor units respectively constructed from transistors having a plurality of different threshold voltages, namely, a device in which a currently used microprocessor unit is switched to another given microprocessor unit included therein in a manner similar to this embodiment in accordance with a load of an instruction (a given instruction stream) to be processed when the load is changed.

1. A semiconductor integrated circuit comprising:
a microprocessor unit for processing a given instruction stream; and
a power control section for controlling power supply to said microprocessor unit,
wherein said microprocessor unit includes a first microprocessor unit that is constructed from transistors having a first threshold voltage and a second microprocessor unit that is constructed from transistors having a second threshold voltage lower than said first threshold voltage and is instruction set compatible with said first microprocessor unit,
in processing that is executed by said microprocessor unit including said first and second microprocessor units and is composed of a first operation mode for performing a general operation with a given operating ratio and a second operation mode for performing an operation with a lower operating ratio than said first operation mode, said given instruction stream includes a first MPU switching instruction received by said first microprocessor unit for switching said first microprocessor unit to said second microprocessor unit when said second operation mode with said lower operating ratio is changed to said first operation mode with said given operating ratio, and a second MPU switching instruction received by said second microprocessor unit for switching said second microprocessor unit to said first microprocessor unit when said first operation mode with said given operating ratio is changed to said second operation mode with said lower operating ratio, and
when said first operation mode is changed to said second operation mode, said microprocessor unit including said first and second microprocessor units performs, by using said power control section, power control for making said second microprocessor unit having received said second MPU switching instruction supply power to said first microprocessor unit and disconnecting said second microprocessor unit from power, and when said second operation mode is changed to said first operation mode, said microprocessor unit including said first and second microprocessor units performs, by using said power control section, power control for making said first microprocessor unit having received said first MPU switching instruction supply power to said second microprocessor unit and disconnecting said first microprocessor unit from power.

2. The semiconductor integrated circuit of claim 1, further comprising:
a first memory section and a first control section in said first microprocessor unit;
a second memory section and a second control section in said second microprocessor unit; and
an external memory section for storing data of said first or second memory section,
wherein, in switching said first and second microprocessor units on the basis of said first and second MPU switching instructions, said first and second control sections control, by using said external memory section, data transfer from said first or second memory section of said first or second microprocessor unit to be disconnected from power to said second or first memory section of said second or first microprocessor unit to be supplied with power.

3. A microprocessor unit switching method for switching said first and second microprocessor units of said semiconductor integrated circuit of claim 2, comprising:
an MPU1 data transferring step of transferring data stored in said first memory section of said first microprocessor unit to said external memory section in accordance with said given instruction stream to be processed by said first microprocessor unit;
an MPU2 power supplying step of making said power control section supply power to a power supply system of said second microprocessor unit in accordance with said given instruction stream to be processed by said first microprocessor unit;
an MPU1 power disconnecting step of making said power control section disconnect a power supply system of said first microprocessor unit from power in accordance with said given instruction stream to be processed by said first microprocessor unit;
an MPU2 data storing step of storing said data having been stored in said external memory section in said second memory section of said second microprocessor unit in accordance with said given instruction stream to be processed by said second microprocessor unit;
an MPU2 data transferring step of transferring data stored in said second memory section of said second microprocessor unit to said external memory section in accordance with said given instruction stream to be processed by said second microprocessor unit;
an MPU1 power supplying step of making said power control section supply power to said power supply system of said first microprocessor unit in accordance with said given instruction stream to be processed by said second microprocessor unit;
an MPU2 power disconnecting step of making said power control section disconnect said power supply system of said second microprocessor unit from power in accordance with said given instruction stream to be processed by said second microprocessor unit; and
an MPU1 data storing step of storing said data having been stored in said external memory section in said first memory section of said first microprocessor unit in accordance with said given instruction stream to be processed by said first microprocessor unit.

4. The semiconductor integrated circuit of claim 1,
wherein said first microprocessor unit includes a first memory section and a first control section,
said second microprocessor unit includes a second memory section and a second control section,
said microprocessor unit including said first and second microprocessor units further includes:
a data transfer section for performing data transfer between said first memory section and said second memory section; and
an MPU control section for controlling said data transfer performed by said data transfer section on the basis of signals received from said first and second control sections, and
in switching said first and second microprocessor units on the basis of said first and second MPU switching instructions, said first and second control sections controls, by using said MPU control section, said data transfer section in such a manner that data of said first or second memory section of said first or second microprocessor unit to be disconnected from power is transferred to said second or first memory section of said second or first microprocessor unit to be supplied with power.

5. A microprocessor unit switching method for switching said first and second microprocessor units of said semiconductor integrated circuit of claim 4, comprising:
an MPU2 power supplying step of making said power control section supply power to a power supply system of said second microprocessor unit in accordance with said given instruction stream to be processed by said first microprocessor unit;
an MPU1 data transferring step of transferring data stored in said first memory section of said first microprocessor unit to said second memory section of said second microprocessor unit in accordance with said given instruction stream to be processed by said first microprocessor unit;
an MPU1 power disconnecting step of making said power control section disconnect a power supply system of said first microprocessor unit from power in accordance with said given instruction stream to be processed by said first microprocessor unit;
an MPU1 power supplying step of making said power control section supply power to said power supply system of said first microprocessor unit in accordance with said given instruction stream to be processed by said second microprocessor unit;
an MPU2 data transferring step of transferring data stored in said second memory section of said second microprocessor unit to said first memory section of said first microprocessor unit in accordance with said given instruction stream to be processed by said second microprocessor unit; and
an MPU2 power disconnecting step of making said power control section disconnect said power supply system of said second microprocessor unit from power in accordance with said given instruction stream to be processed by said second microprocessor unit.

6. The semiconductor integrated circuit of claim 1,
wherein said first microprocessor unit includes a first memory section and a first control section,
said second microprocessor unit includes a second memory section and a second control section,
said microprocessor unit including said first and second microprocessor units further includes:
a data write through section for performing data pass between said first memory section and said second memory section; and
an MPU control section for controlling said data pass performed by said data write through section on the basis of signals received from said first and second control sections, and
in switching said first and second microprocessor units on the basis of said first and second MPU switching instructions, said first and second control sections control, by using said MPU control section, said data write through section in such a manner that data of said first or second memory section of said first or second microprocessor unit to be disconnected from power is passed to said second or first memory section of said second or first microprocessor unit to be supplied with power.

7. The semiconductor integrated circuit of claim 1,
wherein said first microprocessor unit includes a first control section,
said second microprocessor unit includes a second control section, and
said microprocessor unit further includes:
a memory section shared by said first and second microprocessor units; and
an MPU control section for controlling data store in said memory section on the basis of signals received from said first and second control sections.

8. The semiconductor integrated circuit of claim 7,
wherein said memory section is constructed from transistors having a threshold voltage equal to said first threshold voltage or said second threshold voltage.

9. The semiconductor integrated circuit of claim 1,
wherein said first microprocessor unit includes a first memory section and a first control section,
said second microprocessor unit includes a second memory section and a second control section, and
each of said first and second microprocessor units has both a master function and a slave function for performing data transfer between said first and second memory sections through master/slave operations of said first and second control sections.

10. A microprocessor unit switching method for switching said first and second microprocessor units of said semiconductor integrated circuit of claim 9, comprising:
an MPU2 power supplying step of making said power control section supply power to a power supply system of said second microprocessor unit in accordance with said given instruction stream to be processed by said first microprocessor unit;
an MPU1 data transferring step of transferring data stored in said first memory section of said first microprocessor unit to said second memory section of said second microprocessor unit in accordance with said given instruction stream to be processed by said first microprocessor unit;
an MPU1 power disconnecting step of making said power control section disconnect a power supply system of said first microprocessor unit from power in accordance with said given instruction stream to be processed by said first microprocessor unit;
an MPU1 power supplying step of making said power control section supply power to said power supply system of said first microprocessor unit in accordance with said given instruction stream to be processed by said second microprocessor unit;
an MPU2 data transferring step of transferring data stored in said second memory section of said second microprocessor unit to said first memory section of said first microprocessor unit in accordance with said given instruction stream to be processed by said second microprocessor unit; and
an MPU2 power disconnecting step of making said power control section disconnect said power supply system of said second microprocessor unit from power in accordance with said given instruction stream to be processed by said second microprocessor unit.

11. The semiconductor integrated circuit of claim 9, further comprising, outside said microprocessor unit including said first and second microprocessor units, an external data transfer section for performing said data transfer between said first and second memory sections through independent processing controlled by said first and second control sections.

12. A microprocessor unit switching method for switching said first and second microprocessor units of said semiconductor integrated circuit of claim 11, comprising:
an MPU2 power supplying step of making said power control section supply power to a power supply system of said second microprocessor unit in accordance with said given instruction stream to be processed by said first microprocessor unit;
an MPU1 data transferring step of transferring data stored in said first memory section of said first microprocessor unit to said second memory section of said second microprocessor unit in accordance with said given instruction stream to be processed by said first microprocessor unit;
an MPU1 power disconnecting step of making said power control section disconnect a power supply system of said first microprocessor unit from power in accordance with said given instruction stream to be processed by said first microprocessor unit;
an MPU1 power supplying step of making said power control section supply power to said power supply system of said first microprocessor unit in accordance with said given instruction stream to be processed by said second microprocessor unit;
an MPU2 data transferring step of transferring data stored in said second memory section of said second microprocessor unit to said first memory section of said first microprocessor unit in accordance with said given instruction stream to be processed by said second microprocessor unit; and
an MPU2 power disconnecting step of making said power control section disconnect said power supply system of said second microprocessor unit from power in accordance with said given instruction stream to be processed by said second microprocessor unit.

13. The semiconductor integrated circuit of any of claims 2, 4, 6 and 9, further comprising at least one third microprocessor unit that is constructed from transistors having a third threshold voltage different from said first and second threshold voltages and is instruction set compatible with said first and second microprocessor units,
wherein said given instruction stream includes an MPU switching instruction for allocating a given microprocessor unit out of said first, second and third microprocessor units constructed from the transistors respectively having said first, second and third threshold voltages to a load of processing to be performed, in such a manner that a low threshold voltage is selected when said load is large and a high threshold voltage is selected when said load is small, and for switching a currently operated microprocessor unit to said given microprocessor unit when said load of processing is changed, and
when said MPU switching instruction appears in executing said given instruction stream, said currently operated microprocessor unit executes said given instruction stream by performing, by using said power control section, power control for supplying power to said given microprocessor unit to be switched and disconnecting said currently operated microprocessor unit from power.

14. A semiconductor integrated circuit comprising:
a microprocessor unit; and
a power control section for controlling power supply to said microprocessor unit,
wherein said microprocessor unit includes a first microprocessor unit that is constructed from transistors having a first threshold voltage and a second microprocessor unit that is constructed from transistors having a second threshold voltage lower than said first threshold voltage and is instruction set compatible with said first microprocessor unit,
in said microprocessor unit, said second microprocessor unit operates in a first operation mode for performing a general operation with a given operating ratio and the first microprocessor unit operates in a second operation mode for performing an operation with a lower operating ratio than said first operation mode,
when said first operation mode is changed to said second operation mode, said second microprocessor unit performs, by using said power control section, power control for supplying power to said first microprocessor unit and disconnecting said second microprocessor unit from power, and
when said second operation mode is changed to said first operation mode, said first microprocessor unit performs, by using said power control section, power control for supplying power to said second microprocessor unit and disconnecting said first microprocessor unit from power.
